(19) United States
(12) Patent Application Publication
(10) Pub. No.: US 2009/0246338 A1
(43) Pub. Date: Oct. 1, 2009

(54) METHOD FOR PICKLING GINGER FOR SHIPMENT

(75) Inventors: Yoshiji Kono, Monterey Park, CA (US); Keita Ito, Redondo Beach, CA (US); Takeshi Kawakami, Gardena, CA (US)

Correspondence Address: BRUCE A. JAGGER, 6701 CENTER DRIVE, SUITE 610, LOS ANGELES, CA, 90045, US

(73) Assignee: Golden Ginger Products, Inc.

(21) Appl. No.: 12/060,703

(22) Filed: Apr. 1, 2008

(51) Int. Cl. A23L 1/221; A23P 1/00; B65B 29/00

(52) U.S. Cl. 426/397

(57) ABSTRACT

A method for the bulk preparation and individual distribution of fresh ginger base from a central location involves selecting fresh ginger root and comminuting it to produce comminuted ginger. A generally liquid mixture is also prepared, which contains at least water, natural sweetener, edible acid, and salt. A predetermined amount of the comminuted ginger is packaged in a substantially air-tight container. The comminuted ginger occupies more than approximately 90 percent of the internal volume of the container. The comminuted ginger is cooled to a temperature that is above its freezing point. A pre-selected amount of the generally liquid mixture is placed into a receptacle. The pre-selected amount is generally proportional to the predetermined amount of comminuted ginger. The container and the receptacle are distributed from the central location to a site of intended use.

### BACKGROUND OF THE INVENTION

(1) Field of the Invention

The present invention relates generally to the field of fresh ginger preparation and more particularly to the bulk preparation and shipment of fresh ginger base.

(2) Description of the Related Art

Ginger is commonly used as a spice in cuisines throughout the world. Ginger apparently originated in Southern China, but has now spread throughout most of the world. Ginger is prized for its delicate flavor. The flavor and/or appearance of ginger, particularly fresh ginger, is easily degraded by improper storage or preparation to the point where it is no longer acceptable to sophisticated consumers. Fresh ginger must be properly prepared, handled, and stored to provide the desired flavor in the final prepared cuisine. The proper preparation of fresh ginger is such a demanding, labor intensive, and time consuming task that in the food service industry, a fresh ginger base mixture is often prepared in bulk at a central location and then shipped to individual restaurants, institutions, or caterers where the final preparation of ginger flavored cuisine is accomplished by a chef.

The preparation of a bulk fresh ginger base mixture at a central location had been previously accomplished, for example, by mixing freshly cleaned and sliced ginger in various proportions with, for example, salt, water, one or more edible acids such citric, malic, or acetic acid, or the like, and a natural sweetener such as sugar and/or corn syrup, or the like. At least part of the acetic acid, when present, was often in the form of vinegar. This entire base mixture was then placed in a single container, and shipped immediately to a chef at a site of intended use for inclusion in various recipes. The base mixture had to be delivered within approximately a day of its preparation to insure that the desired flavor was preserved. The shelf life of the base mixture was relatively limited (typically, no more than three or four days). Approximately one-half or more of the weight of the base mixture was water. Thus, when measured by weight, as much as one-half or more of the cost of shipping the base mixture was accounted for by the water. The chef was limited to working with the ginger base mixture as it was delivered to him. That is, a chef did not have the flexibility to adjust, for example, the sweetness or saltiness of the base mixture, except to make it sweeter or saltier. A chef's flexibility in proportioning the ingredients in a recipe was limited to what was permitted by the base mixture. The close and expert control at a central location of the steps of preparing the liquid mixture, the fresh ginger, and combining the ingredients in the desired proportions was generally thought to be necessary to achieve the desired flavor and appearance in the final cuisine. The prepared fresh ginger base was typically packed into a plastic bag, which was sealed to exclude as much air as possible. Then the bag was packed into a plastic bucket to protect it during shipment and storage. The packaged fresh ginger base was then delivered under refrigeration (but not frozen) as soon as possible to the site of intended use where it was to be incorporated into cuisine. It was generally believed that this was the only way to provide fresh ginger base that would satisfy discriminating palates.

Those skilled in the ginger preparation art have long recognized the problems with the previous expedients for the preparation, shipment and storage of fresh ginger base mixtures. Changes have generally not been attempted because the reputation of the restaurant or other institution was at stake. Any perceived reduction in the quality of the fresh ginger would be very detrimental to that reputation.

### SUMMARY OF THE INVENTION

Embodiments of the present invention have been developed in response to the current state of the art, and in particular, in response to these and other problems and needs that have not been fully or completely solved by currently available expedients in the fresh ginger base preparation art. Thus, embodiments of the present invention effectively resolve at least the problems and shortcomings identified herein. Certain embodiments may be particularly suitable for use in the preparation of fresh ginger base mixtures that weigh less to ship, allow a chef flexibility in proportioning ingredients in a recipe that includes such a ginger base in the mixture, and extends the shelf life of the ginger base mixture, all without compromising the taste or appearance of cuisine made from such a ginger base.

An embodiment of the bulk preparation at a central location and individual distribution of a fresh ginger base according to the present invention may comprise selecting fresh ginger root and comminuting it to produce comminuted ginger. The comminuted ginger has a freezing point that is typically several degrees below the freezing point of water. A generally liquid mixture may be prepared, which may contain at least water, natural sweetener, edible acid, and salt. As compared with prior expedients wherein all of the ingredients were mixed together and distributed in one common container, the generally liquid mixture may be more concentrated. That is, it contains less water. This reduces the weight, the volume, and the shipping costs. A predetermined amount of the comminuted ginger may be packaged in a substantially air-tight container having an internal volume. The comminuted ginger may occupy more than approximately 90 percent of the internal volume of the substantially air-tight container. In certain embodiments, there may be from approximately 10 to 2 percent by volume of void volume within the substantially air-tight container. The comminuted ginger may be cooled to a temperature above the freezing point of the comminuted ginger. A pre-selected amount of the generally liquid mixture may be put into a receptacle. The pre-selected amount may be generally proportional to the predetermined amount of comminuted ginger in the substantially air-tight container. The container and the receptacle may be distributed from the central location to a site of intended use.

In certain embodiments a plurality of the containers and receptacles may be distributed to a plurality of sites of intended use from one central location. At least some of the sites of intended use may be more than a mile from the central location.

In certain embodiments the substantially air-tight container may be a flexible plastic envelope. The receptacle may also comprise a flexible plastic bag separate from the flexible plastic envelope. The substantially air-tight container and the receptacle are separate from one another. The two may be distributed as a unit (for example, within a common bucket or pail) with the expectation that the separate contents will be mixed together as a chef may desire at a site of intended use to form a batch of fresh ginger base. The chef has the option of using all or only a portion of the contents of the substantially air-tight container and the receptacle in the proportions in which they were distributed or in any proportions that may be desired. According to certain embodiments, the predetermined amount of comminuted ginger in the substantially air-tight container has a first weight, and the pre-selected amount of generally liquid mixture in the receptacle has a second weight. The second weight may be from approximately 80 to 120 percent by weight of the first weight.

In certain embodiments, the fresh ginger root may comprises at least approximately 80 percent by weight of the comminuted ginger. A certain amount of water may be required to accomplish the desired comminution of the ginger root. The amount of water naturally occurring in the ginger root may depend on the conditions under which it was grown, picked, stored, processed, and transported. According to some embodiments, the amount of water present during comminution may be brought to a standard level so that proper comminution may be accomplished. If the fresh ginger root is very dry, it may require as much as 20 percent by weight of added water to bring the water content to a standard level.

According to certain embodiments, the comminuted ginger and the generally liquid mixture may be cooled to a temperature of from approximately 1 to 15 degrees centigrade above the freezing point of the comminuted ginger. In certain embodiments, a cooling step may be carried out within a few minutes (1 to 30 minutes, for example) after the comminuted ginger and the generally liquid mixture are formed. They may be maintained in a cooled state throughout storage and distribution until they are used at a site of intended use.

An appreciation of other embodiments of the present invention and an understanding of it may be achieved by referring to the accompanying detailed description.

### DETAILED DESCRIPTION OF THE INVENTION

Embodiments of the present invention provide benefits across a broad spectrum of the fresh ginger base preparation art. While the description which follows hereinafter is meant to be representative of a number of such embodiments, it is not exhaustive. As those skilled in the art will recognize, the embodiments taught herein may be readily adapted to many uses. This specification and the claims appended hereto should be accorded a breadth in keeping with the scope and spirit of the invention being disclosed despite what might appear to be limiting language imposed by the requirements of referring to the specific embodiments disclosed.

As used herein, “comminute” and variations of the term, such as, “comminuting”, “comminution”, and “comminuted” are intended to include grinding, shredding, slicing, lacerating, dicing, crushing, and all other size reduction and physical form operations. As used herein, the term “comprise”, and variations thereof, such as “comprising”, “comprises”, and “comprised”, are not intended to exclude other additives, components, or steps.

Table I sets forth the detailed ingredients in two embodiments. Fructose is perceived by a consumer of these fresh ginger bases as being sweater than ordinary sugar. The Second Embodiment is perceived as being sweater than the First. In these embodiments, the water by weight accounts for from approximately 25 to 30 percent of the total Embodiment. In further embodiments, the water by weight may account for from approximately 20 to 40 percent of the total embodiment.

TABLE I

| Generally | | |
|---|---|---|
| Liquid | First | Second |
| Mixture | Embodiment | Embodiment |
| Ingredient | Amount lb. | Amount lb. |
| Water | 10.146 | 7.472 |
| Sugar | 5.258 | 0.000 |
| Fructose | 0.528 | 5.000 |
| Salt | 0.594 | 0.280 |
| Vinegar | 0.066 | 0.040 |
| Citric Acid | 0.066 | 0.040 |
| Malic Acid | 0.066 | 0.040 |
| Acetic Acid | 0.176 | 0.132 |
| Total Juice | 16.900 | 13.004 |
| Amount | | |

In A Separate Package

| | | | | |
|---|---|---|---|---|
| Ginger | 15.6 | lb. | 15.5 | lb. |

The proportions and ingredients of the generally liquid mixture ingredients in other embodiments may be varied as desired to accommodate a particular need for flavor, appearance, aroma, consistency, or other culinary objective. In certain embodiments all of the edible acid may be provided by one or more vinegars, such as rice vinegar, or other conventional vinegar. Potassium chloride may be used in place of some or all of the common table salt in some embodiments where the presence of sodium is to be minimized. Common table salt is sodium chloride. Sea salt (a mixture of inorganic salts) may be used. Various natural sweeteners may be used in certain embodiments, including, for example, common sugar, brown sugar, natural and synthetic syrups, molasses, honey, and other natural sugars.

The bulk preparation of fresh ginger base may be easily accomplished through the use of specialized equipment and specially trained workers that are usually not available at the individual sites of intended use. Restaurants, institutions, and other food service providers need a reliable, consistent, and economical source of fresh ginger base. Various systems and methods may be employed to distribute fresh ginger base from a central preparation location to a plurality sites of intended use. According to certain embodiments, a predetermined amount of comminuted ginger, and a pre-selected amount of generally liquid mixture may be packaged separately, and one of each is placed into a common carrier, such as a pail. This makes up one unit, which may then be transported from the central location where it was prepared to the site of intended use. For example, according to some embodiments, a delivery van (usually refrigerated) may take 15 or 20 units from a central location to 15 or 20 different sites of intended use on a regular daily or every other day cycle. In the ordinary course of business some of these sites of intended use may be more than one mile from the central location.

According to certain embodiments, cooling of the fresh comminuted ginger and the generally liquid mixture are accomplished as soon as possible after their preparation. In general, the fresh comminuted ginger is more subject to deterioration than is the generally liquid mixture. The comminuted ginger may be cooled in certain embodiments to a temperature of from approximately 1 to 15 degrees centigrade above its freezing point. The freezing point of the fresh comminuted ginger may be depressed by the presence of dissolved substances by from approximately 1 to as much as 5 or 10 degrees centigrade below the freezing point of pure water (0 degrees centigrade). The freezing point of the generally liquid mixture is likewise depressed, but it is generally not as susceptible to spoilage as the comminuted ginger

The concentrations of the respective ingredients in the generally liquid mixture usually do not approach the saturation level, but this mixture may include other substances that are not or only partially soluble so that there may not be a true solution. The phrase “generally liquid mixture” includes true solutions, suspensions, slurries, and the like, so long as the mixture generally will not hold its own shape and flows like a liquid.

While the present invention is described herein with reference to illustrative embodiments, it should be understood that the invention is not limited thereto. Those having ordinary skill in the art and access to the teachings provided herein will recognize additional modifications, and embodiments within the scope thereof. It is therefore intended by the appended claims to cover any and all such modifications and embodiments within the scope of the present invention.

What is claimed is:

1. A method for the bulk preparation and individual distribution of fresh ginger base from a central location comprising:
selecting fresh ginger root and comminuting it to produce comminuted ginger, the comminuted ginger having a freezing point;
preparing a generally liquid mixture containing at least water, natural sweetener, edible acid, and salt;
packaging a predetermined amount of the comminuted ginger in a substantially air-tight container having an internal volume, the comminuted ginger occupying more than approximately 90 percent of the internal volume, and cooling the comminuted ginger to a temperature above the freezing point;
putting a pre-selected amount of the generally liquid mixture into a receptacle, the pre-selected amount generally being proportional to the predetermined amount; and
distributing the container and the receptacle from the central location to a site of intended use.

2. The method of claim 1 including distributing a plurality of the containers and receptacles to a plurality of sites of intended use from one central location, at least some of the sites of intended use being more than a mile from the central location.

3. The method of claim 1 including selecting a substantially air-tight container that comprises a flexible plastic envelope.

4. The method of claim 1 including selecting a receptacle that comprises a flexible plastic envelope.

5. The method of claim 1 that includes distributing the container and the receptacle as a unit, which unit contains enough of the comminuted ginger and the generally liquid mixture to, when mixed together at the site of intended use, form one batch of the fresh ginger base.

6. The method of claim 1 wherein the comminuted ginger has a first weight and the generally liquid mixture has a second weight, the second weight being from approximately 80 to 120 percent by weight of the first weight.

7. The method of claim 1 wherein the cooling is to a temperature of from approximately 1 to 15 degrees centigrade above the freezing point.
